(19) United States
(12) Patent Application Publication
(10) Pub. No.: US 2008/0031451 A1
(43) Pub. Date: Feb. 7, 2008

(54) METHOD AND SYSTEM FOR SECURITY OF DATA TRANSMISSIONS

(76) Inventor: Jean-Francois Poirier, Deux-Montagnes (CA)

Correspondence Address: BERESKIN AND PARR, 40 KING STREET WEST, BOX 401, TORONTO, ON, M5H 3Y2, US

(21) Appl. No.: 11/559,164

(22) Filed: Nov. 13, 2006

Related U.S. Application Data
(60) Provisional application No. 60/735,917, filed on Nov. 14, 2005.

(51) Int. Cl. H04N 7/167

(52) U.S. Cl. 380/228

(57) ABSTRACT

The described embodiments relate generally to data processing systems and methods for encryption and decryption of a subscription-based data service, such as a satellite or cable television service. These aspects are generally based on use of an encryption key by the service provider to encode the data prior to transmission and on a decryption key that is based on the encryption key and on a unique identifier of a particular target receiving device.

### CROSS-REFERENCE TO RELATED APPLICATIONS

This application claims the benefit of U.S. Provisional Application Ser. No. 60/735,917 filed on Nov. 14, 2005, the entire contents of which is hereby incorporated by reference.

### TECHNICAL FIELD

The present invention relates to methods and systems for security of data transmissions. In particular, the invention relates to methods and systems for security of data transmissions from a broadcast service provider to a subscriber of the broadcast service.

### BACKGROUND

Unauthorized receipt of broadcast signals, such as satellite or cable television signals, is problematic for broadcast service providers, as it represents lost revenue for a service that is usually only provided on a paid subscription basis.

Many of today's cable and satellite television subscription services encrypt the television signals prior to broadcasting. Once a subscriber subscribes to the service (for specific channels), the subscriber is provided with one or more decryption keys for encrypting the subscribed channels. The subscriber may be provided with the keys stored on a smart card or other electronically readable device.

For satellite television, each channel is encrypted with a specific encryption key and this encryption key is provided on the smart card to all subscribers of the channel. Thus, for a given channel, the same decryption key may be used by all subscribers to decrypt that channel. Accordingly, if a person is able to determine what the decryption key is for a particular channel, that person may make that decryption key publicly available, for example over the Internet. This means that would-be thieves of the subscriptions service may decrypt the channel without having to obtain the decryption key from the service provider and thus avoid paying the subscription fees.

Even though service providers in the above situation regularly change the encryption keys for each channel in an effort to reduce the occurrence of unauthorized use of the encryption keys, the new keys are quickly determined by would be unauthorized viewers and distributed publicly via the Internet, thus defeating the purpose of changing the encryption keys.

It is desired to address or ameliorate one or more of the disadvantages or shortcomings associated with previous data security methods and systems, or to at least provide a useful alternative thereto.

### SUMMARY

The described embodiments relate generally to data processing systems and methods for encryption and decryption of a subscription-based data service, such as a satellite or cable television service. These aspects are generally based on use of an encryption key by the service provider to encode the data prior to transmission and on a decryption key that is based on the encryption key and on a unique identifier of a particular target receiving device.

Certain embodiments relate to a data processing method. The method comprises the following steps: generating at a subscriber terminal a service request, the service request including a service identifier and a unique identifier of the subscriber terminal; providing the service request to a validation entity; receiving a decryption code from the validation entity in response to the service request, the decryption code being based on the unique identifier and an encryption key; receiving an encrypted data service at the subscriber terminal, the encrypted data service being based at least in part on the service identifier and being encrypted using the encryption key; and processing the encrypted data service using the decryption code to generate decrypted data.

Other embodiments relate to a method of providing a service. The method comprises: receiving at a validation entity a service request for an encrypted data service, the service request including a service identifier and a unique identifier of a subscriber terminal; generating a decryption code in response to the service request based on an encryption code and the unique identifier; providing the decryption code to the subscriber terminal; encrypting a data service corresponding to the service identifier using the encryption code; and transmitting the encrypted data service to the subscriber terminal for decryption of the data service by the subscriber terminal using the decryption code.

The encrypted data service may be a subscription-based service. The subscription-based service may be a cable television service, a satellite television service or a radio frequency (RF) broadcast service, for example.

Further embodiments relate to a method of updating a decryption key for a subscription service. The method comprises: a) determining that a validity period of an encryption key has expired, the encryption key being specific to a service; b) generating a new encryption key for the service; c) determining a receiver identifier of each subscriber of the service; d) generating for each subscriber a new decryption key for the service based on the new encryption key and the receiver identifier of the respective subscriber; and e) transmitting to a receiver of each subscriber the respective new decryption key.

Still further embodiments relate to computer readable media having stored therein, or otherwise embodying, computer program instructions which, when executed by one or more computer processors, cause the one or more computer processors to perform any of the methods described above.

Still further embodiments relate to a data processing device for an encrypted data service, the device comprising: a processor for receiving and processing the encrypted data service from a service provider, the processor being configured to determine a first unique identifier of an encrypted data service; and a memory storing a decryption code corresponding to the first unique identifier and a second unique identifier of the data processing device; wherein the processor is configured to decrypt the encrypted data service based on the decryption code and the second unique identifier.

Still further embodiments relate to a system for providing a data service, comprising: a service provider for providing an encrypted data service, the encrypted data service having associated therewith a service identifier and being encrypted according to an encryption code; a receiver in communication with the service provider to receive the encrypted data service, the receiver comprising a processor for processing the encrypted data service and configured to determine the service identifier of the encrypted data service and a memory for storing a decryption code associated with the service identifier, the processor being configured to decrypt the encrypted data service based on the decryption code and a receiver identifier of the receiver; and a code provider associated with the service provider for generating the decryption code based on the encryption code and the receiver identifier and for providing the decryption code in response to a service request.

### BRIEF DESCRIPTION OF THE DRAWINGS

FIG. 1 is a block diagram of a system according to one embodiment;

FIG. 2 is a flow chart of a method of providing a subscription-based service;

FIG. 3 is a flow chart of a method of decoding a data service; and

FIG. 4 is a flow chart of a method of updating an encryption key.

### DETAILED DESCRIPTION OF THE EMBODIMENTS

The described embodiments are suited to encoding data to be transmitted or received over a communication medium, such as subscription-based television or video data. Due to its vulnerability to piracy, subscription-based television signals require increased data security in order to limit or prevent unauthorized receipt.

For the purpose of illustration, some embodiments may be described with reference to a cable television service, as one example of data service. It should be understood, however, that the invention may be applied to other forms of data service. Further, the encoding and decoding methods, systems and devices described herein may be employed alone or in combination with other encoding and decoding methods, systems and devices such as may be known to persons skilled in the art.

The terms “encrypt” and “encode” and respective variations thereof are used interchangeably in this description. Similarly, the terms “decrypt” and “decode” and their variations are also used interchangeably.

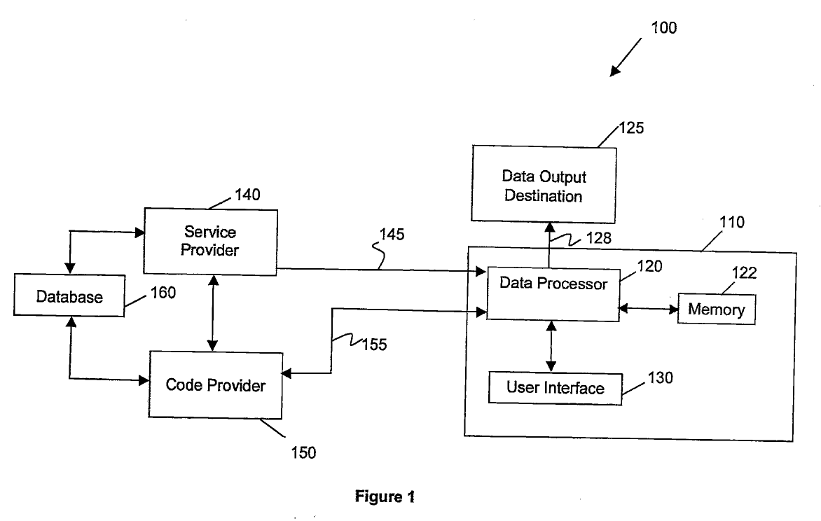

Referring now to the drawings, FIG. 1 is described in further detail. FIG. 1 is a block diagram of a system 100 for receiving and decoding an encoded data source, according to one embodiment. The system 100 includes a receiver 110, such as a subscriber terminal for a satellite or cable television service. Receiver 110 comprises a data processor 120, a memory 122 and a user interface 130.

Data processor 120 performs various data processing operations, including decryption, as described herein, as well as (in a preferred embodiment) communicating with a remotely located code provider 150 to receive decryption codes. Data processor 120 outputs the decrypted data to a data output destination 125, which may include a display, such as a television. A data link 128 interconnects data processor 120 and data output destination 125. The data link 128 may include a cable, such as coaxial cable, or another form of wired connection. Alternatively, data link 128 may be wireless. As long as receiver 110 is suitably connected to means for receiving a data service 145, such as known satellite and cable signal receiving devices, the received signal is received, buffered and processed by data processor 120.

Data service 145 may be of any suitable kind for transmitting a subscribed data service, including cable or satellite television data, video-on-demand, audio or video-streaming or any other unidirectional data service. If the data service 145 includes television data, it may be a single selected channel or multiple selected channels.

In one embodiment, data service 145 may be generalized as one form of data source. In this context, the origin or form of the data source is unimportant to the data processor 120, so long as data processor 120 can identify a unique identifier of the data source (to look up the decryption code within a memory 122) and can process the data according to the format information in the decryption code.

Data processor 120 may be any suitable data processor having a speed and operating capacity to perform a series of logical operations in quick succession. For example, data processor 120 preferably has a data throughput efficiency suitable for handling data quantities in the order of several megabytes to several gigabytes.

Memory 122 may include flash memory or other read-only memory (ROM) and random access memory (RAM). Memory 122 may also comprise registers and cache blocks as necessary for optimal functioning. As will be described in further detail below, memory 122 may store information on predetermined data formats and logic operations that may be used in the decoding of the data service 145. Memory 122 may be distinct from data processor 120, as shown in FIG. 1, or it may form a part of the architecture of data processor 120. Alternatively, memory 122 may be comprised in a removable memory device, such as a USB key, that can be inserted into receiver 110 or removed therefrom to enable or disable the decryption functions of receiver 110. The serial number or other unique identifier of the receiver 110 or data processor 120 (or both) is stored in memory 122. Alternatively, the serial number or other unique identifier may be stored in a memory internal to data processor 120, if memory 122 is separate from data processor 120.

Memory 122 may have its contents encrypted (and decrypted) according to the methods described in co-owned and co-pending U.S. Utility patent application Ser. No. 11/350,839, filed Feb. 10, 2006, the entire contents of which is hereby incorporated by reference.

User interface 130 is in communication with data processor 120 and forms part of a user interface provided by receiver 110. Alternatively, the user interface 130 may be a separate interface device, such as a remote control. If receiver 110 is part of a computer, such as a personal computer (PC) or server system, user interface 130 may be any known form of user interface, including, for example, a keyboard, mouse, display screen or other peripheral, allowing a user of the system 100 to interface with the receiver 110. Alternatively, depending on the form in which receiver 110 is embodied, user interface 130 may include other interface means, such as a small keypad and display, remote control or a two-way speech synthesizer.

Code provider 150 is preferably in communication with data processor 120 over a network, such as the Internet, where the receiver 110, or a host device housing receiver 110, is in connection with the network, either through a wired or wireless connection 155. Alternatively, connection 155 may be established through the same communication link as that used to transmit data service 145 to receiver 110. Thus, data service 145 and connection 155 may share the same communication medium.

Code provider 150 is located remotely from receiver 110 and may include a computer system in communication with, and controlled by, a service provider 140 that provides the data service 145. Code provider 150 records the unique identifiers of each receiver 110 receiving the data service in database 160 and thereby monitors the subscription activities of subscribers of the data service 145. Code provider 150 and service provider 140 may form part of the same entity or may be separate but associated and in communication with each other.

Code provider 150 is responsible for generating and providing suitable decryption codes to each receiver 110 that is subscribed for each service. If data service 145 includes one or more television channels, code provider 150 preferably provides a decryption code for each such channel. Alternatively, multiple channels may share the same decryption code, for example where multiple channels are bundled together in a service package. If data service 145 includes a video-on-demand service or another form of audio, video or audio-visual streaming service, code provider 150 provides a decryption code specific to that service. Each decryption code is generated by the code provider 150 according to a (preferably randomly-generated) encryption key and the unique identifier of the receiver to which the service is to be provided. Each decryption code is stored in database 160 against the relevant subscriber record.

Code provider 150 is also responsible for generating suitable encryption keys for encrypting the data service 145 and for determining the encryption format to be used in encrypting the data service 145. The encryption format for each distinct data service may be randomly selected from a plurality of predetermined data formats having varying parameters. Such parameters may include, but are not limited to, the logic functions to be applied in the encryption and decryption, whether a variable key is used and, if so, how it is generated, key length, data block size, how many logic operations are to be performed and key validity period. Each of the various encryption formats has a corresponding decryption format stored in memory 122 and accessible by specifying an index value of the format code.

For services of a limited duration (i.e. a few hours or a few days), the decryption code provided for that service preferably specifies an expiry date or a validity duration after which the decryption code will become invalid and unusable. Whether or not the decryption code has an expiry date, the decryption code is stored in memory 122 for subsequent use when decrypting the data encoded in data service 145. The contents of the decryption code provided by code provider 150 is described in further detail below in relation to Tables 3A to 3C.

Because the decryption code provided to each receiver 110 is specific to that receiver (because the decryption key specified in the decryption code is generated at least in part based on a unique identifier of receiver 110 or of data processor 120), the decryption code provided to one receiver is not useable by another receiver.

Code provider 150 preferably allows fully automated data exchange with data processor 120 for downloading requested or updated decryption codes via connection 155. Alternatively, code provider 150 may allow the updated decryption codes to be downloaded through a form on a web page, or received through an automated voice response (AVR) system or a call center operator, for example.

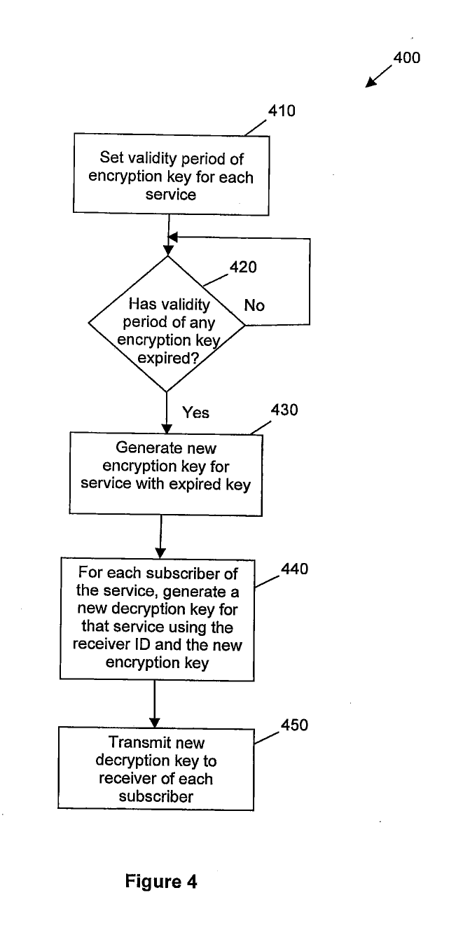

Database 160 is used to store subscriber account information, including the unique identifier of the receiver 110 and/or data processor 120 being used by the subscriber. Further, database 160 stores the encryption codes (including encryption format information) currently used for each data service provided by service provider 140. The encryption codes are updated regularly, as described in relation to FIG. 4. Database 160 may comprise any suitable data structures and may be distributed across multiple data stores or may be supported by a dedicated data store. Database 160 is accessible to, and writable by, either or both of service provider 140 and code provider 150.

Data output destination 125 may be any suitable output device for receiving and processing the processed data from data processor 120, such as a computer processor, visual display and/or sound system.

Data output destination 125 may include a digital signal processor (not shown) and a data output (not shown). If the data output destination is a television or other visual display, for example, the digital signal processor will process the data stream output from data processor 120 and pass the processed data to the data output to display the video information. The form and function of the digital signal processor and data output will depend on the form and function of data output destination 125, which may include any of a number of visual, audio, audio-visual or other devices that are designed to receive and output or store the received data.

In one embodiment of system 100, the data stream output from data processor 120 to the digital signal processor may be unencrypted. In an alternative embodiment of system 100, the data output from data processor 120 may be encrypted. If such encryption is used, it may be based upon a simple encryption scheme using a key known to the data processor 120, such as a serial number of data processor 120. For example, data processor 120 may encode the data that it has decrypted from data service 145 using a new key, and send the encoded data to the digital signal processor of data output destination 125.

In order for the digital signal processor to be able to decode the data from data processor 120, it must have received a decryption key cryptologically matched, or otherwise corresponding (i.e. as a logical inverse), to the encryption key used by data processor 120 to encode the data. Accordingly, prior to transmitting the encoded data, data processor 120 transmits a decoding key to the digital signal processor, which stores the key in memory (not shown).

The decoding key may be stored in the memory of the digital signal processor in a protected manner, such as is described in U.S. patent application Ser. No. 11/350,839. Subsequent to receipt of the decoding key from data processor 120, the digital signal processor processes all incoming data using the decoding key. For this purpose, a simple logic function, such as an XOR or hash function, may be used, both at the data processor 120 during the encoding and at the digital signal processor during the decoding. The digital signal processor may store the decoding key (which is the logical inverse of the encoding key) permanently or until it is rewritten by data processor 120, for example using a specific key write command. The digital signal processor may only accept a key rewrite command that specifies the previous key, to authenticate the command.

The encoding of data transmitted by data processor 120 to data output destination 125 advantageously causes the data output destination to only be able to read data from receiver 110. In the example where receiver 110 is a cable television receiver and data output destination 125 is a television, this would have the effect that, if the television is stolen, it cannot be used by any receiver other than that which uses the correct encoding key in transmitting its output signal to the television, thereby thwarting one possible purpose of the theft. This is an advantageous disincentive to prospective thieves of televisions and other similarly protected home entertainment equipment, including speakers.

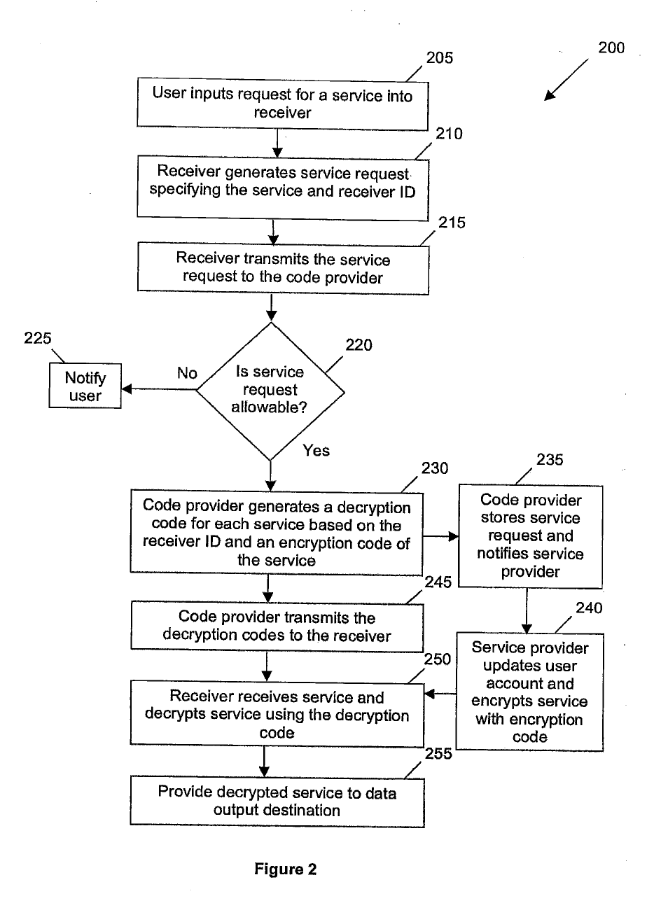

Referring now to FIG. 2, a method of providing a subscription-based service is described, the method being designated by reference indicator 200. For purposes of illustration, method 200 is described by way of example with reference to a cable or satellite television service as the data service 145. It should be understood, however, that reference hereunder to “channel” is a reference to one exemplary form of service and should not be construed to limit the form of data service to which the invention may apply.

Method 200 begins at step 205 when a user inputs into user interface 130 a request for a service from service provider 140. In response to the user input via user interface 130, data processor 120 checks whether it already has access to the service and, if not, generates a service request specifying the service and the unique identifier of the receiver 110 or data processor 120.

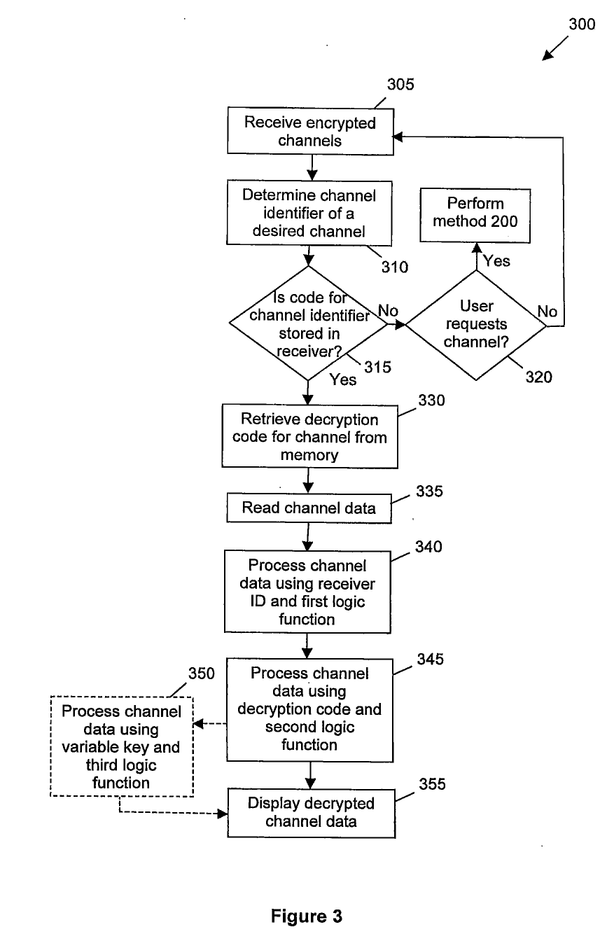

In step 205, data processor 120 checks memory 122 to determine whether a decryption code corresponding to a channel identifier of the desired channel has previously been received and, if so, whether the decryption code remains valid. If a valid decryption code is stored in memory 122, then following step 205, data processor 120 proceeds to process the encoded channel data at step 250 to decrypt that data (according to the method described below in relation to FIG. 3) using the stored decryption code and provide the decrypted data to data output destination 125.

In step 210, data processor 120 determines the channel identifier of the channel desired to be received by the user from input at user interface 130, and accesses a unique identifier of the receiver 110 stored in memory 122. In an alternative embodiment, a unique identifier of data processor 120 may be provided instead of a unique identifier of receiver 110 as the basis for requesting the decryption code from code provider 150.

At step 210, if there is no decryption code stored for the particular channel desired to be viewed, or if the stored code is no longer valid, data processor 120 generates a service request based on a channel identifier of the desired channel and the unique identifier of the receiver 110 (or data processor 120) and provides the service request to code provider 150. At step 215, data processor 120 transmits the generated service request to the code provider 150 over the network connection 155. If data processor 120 is not in communication with code provider 150, the user is requested via user interface 130 to provide the channel identifier and the unique identifier of the receiver 110 to the code provider 150 in an alternative fashion, for example by telephone or through a web browser on an independent computer, and to retrieve a corresponding decryption code.

In step 215, data processor 120 preferably provides the channel and receiver unique identifiers to code provider 150 in one or more data packets, which may be transmitted in encrypted form using, for example, a secure socket layer (SSL) protocol. Once code provider 150 receives the channel request packet, it parses the packet at step 220 to determine the channel and receiver unique identifiers. Code provider 150 then uses the receiver unique identifier to try to find a corresponding data record and corresponding account information of receiver 110. Code provider 150 checks the account information to ascertain that the user is authorized to receive the requested channel.

At step 220, code provider 150 determines whether the service request received from receiver 110 is allowable. The service request may not be allowable for various reasons, including, for example, that the service has been intentionally blocked by a parent to avoid a child viewing restricted material, that the unique identifiers in the service request are not recognized or that the customer's account is at its credit limit. If the code provider 150 determines that the service request is not allowable, code provider 150 transmits a communication back to receiver 110 for displaying a suitable notification to that effect to the user, at step 225, via user interface 130. Thus, code provider 150 acts as a validation entity for validating the service request prior to providing the data service 145.

If the service request is considered to be allowable, code provider 150 generates a decryption code for each service specified in the service request, based on the unique identifier provided by data processor 120 and an encryption code specific to each requested service, at step 230.

Code provider 150 then proceeds, at step 235, to store the service request from receiver 110 in database 160 and notifies service provider 140 of the service request and that it was considered allowable. At step 240, service provider 140 (or alternatively code provider 150) updates the account status of the user, as recorded in database 160, to reflect the added or modified service. As part of step 240, service provider 140 encrypts the service with a predetermined encryption code, which is the same as the encryption code used in step 230 to generate a receiver-specific encryption code. The encryption code used at step 240 is independent of the receiver and is the same for all subscribers of the service.

Following step 230, code provider 150 transmits the one or more decryption codes generated at step 230 to receiver 110, at step 245. At step 250, receiver 110 receives the encrypted data service 145 and decrypts the data service using the applicable decryption code received at step 245. In one embodiment, the receiver 110 may receive the encrypted data service 145 constantly but, without a valid decryption code, receiver 110 is unable to process the encrypted data service 145 into meaningful information. As part of step 250, receiver 110 determines a decryption key and format information from the received decryption code. Use of the decryption key and format information in the decryption process is described in further detail below, with reference to Tables 1, 2A, 2B, 3A, 3B and 3C.

The format information, as will be described further in relation to Tables 3A to 3C, may include data indicative of one or more of a key validity condition, a variable key, an encoding logic function and a checksum. The format information may merely help the data processor 120 to determine that it has received the correct decryption code, for example, by checking the checksum, or it may be used to determine which logic functions to use in decrypting the received channel data or how to determine the variable key (if used in the encoding process) necessary for decryption of the data.

The format information may specify different format codes corresponding to different formats. These format codes and the corresponding decryption formats are stored in memory 122 and are accessed by data processor 120 in response to receipt of the format information. The data processor 120 then uses the decryption formats corresponding to the specified format code when decoding the data service 145.

Once data processor 120 has received the decryption code and format information, it proceeds, at step 250, to process the data service 145 using the decryption key and applicable decryption format determined from the format information. The decrypted data service is then provided, at step 255, to data output destination 125, for further processing, such as by a television, for displaying to the user.

In an alternative embodiment of method 200, method steps 210 and 215 may be performed manually by the prospective consumer of the data service, for example where receiver 110 is not connected to a network or is otherwise unable to communicate directly and automatically with code provider 150.

If steps 210 and 215 are to be performed manually, receiver 110 may guide the consumer to contact code provider 150, by telephone or on-line, for example, and provide the consumer with the appropriate service and receiver identifiers to submit with the service request. The code provider 150 may then provide an appropriate decryption code to the consumer in the same way that it received the service request, so that the user can enter the decryption code into receiver 110 via user interface 130. Alternatively, code provider 150 may provide the decryption code to receiver 110 in the same manner as data service 145 is provided. For example, a sub-channel or control channel of the transmission medium by which data service 145 is transmitted may be used for communicating the decryption code to receiver 110. Further, the transmission medium used for receiving data service 145 may also be used to transmit the service request, if the transmission medium and/or receiver equipment is suitable for outgoing transmissions.

Referring now to FIG. 3, there is shown a process flow diagram of a method of decrypting an encrypted service, the method being designated generally by reference numeral 300. For the purpose of illustration of this embodiment, method 300 is described with reference to a cable or satellite television service having multiple channels.

Method 300 begins at step 305, at which receiver 110 receives the encrypted data service 145 in the form of multiple encrypted channels. When a subscriber wishes to view a particular channel, data processor 120 determines from the received signals a channel identifier for the channel desired to be viewed, at step 310.

At step 315, data processor 120 checks memory 122 to determine whether a decryption code corresponding to the channel identifier is stored therein. If no corresponding decryption code for the desired channel is stored in memory 122, the user is given the opportunity to request the desired channel to be added to the user's subscription, at step 320. If the user chooses to request the channel, appropriate steps within method 200 are performed. Otherwise, if the user chooses not to subscribe to the additional service, the user is returned to step 305.

If the decryption code is stored in memory 122, the decryption code is retrieved from memory 122, at step 330, and data processor 120 reads a block of encoded channel data received from the data service 145 into a first buffer in memory 122, at step 335. As part of step 330, the decryption key and format information are determined from the decryption code. The format information specifies a format code that identifies the logic functions to be used during the decryption, as well as any other relevant processing parameters.

The size of the data block read at step 335 may be the minimum block size used during the encoding. For example, if the data was encoded on a byte-by-byte basis, the encoded data blocks read at step 335 may be the size of a single byte. Alternatively, a multiple of the minimum block size may be read at step 335 so that a number of blocks are buffered together in the first buffer.

At step 340, the quantity of data read into the first buffer at step 335 is processed using a first logic function and a key specific to the receiver 110, which may be the unique identifier of the receiver 110 or of data processor 120. The key used in step 340 must be the same number or code as the unique identifier provided to the code provider 150 at step 210. Step 340 includes processing each data block (of minimum block size) separately according to the first logic function (in a partial decryption step) and the processed blocks are sequentially stored in a second buffer in memory 122.

Each data block is then further processed at step 345, using a second logic function and the decryption code to generate a decrypted block. In an alternative embodiment, the order of steps 340 and 345 can be reversed. If the blocks were originally encoded using a variable key, each decrypted block generated at step 345 is only partially decrypted and undergoes further processing at step 350. Step 350 involves processing the partially decrypted blocks using a third logic function and the variable key to generate fully decrypted blocks. The fully decrypted blocks are then sent, at step 355, to data output destination 125 by data processor 120 for further processing (i.e. displaying on a display). As long as there are more blocks to be processed, steps 335 to 355 are repeated.

The first, second and third logic functions used in steps 340, 345 and 350, respectively, may be any suitable logic function for translating or transposing bits within the data block. Such suitable logic functions may include, but are not limited to, the exclusive-OR (XOR) function, a hash function, addition, subtraction or bit shifting. The first, second and third logic functions may be different or the same and may comprise combinations of functions.

If a variable key was used in the encoding of data service 145, then step 350 is necessary in order to properly decode the data. If a variable key was used in the encoding, the format information received with the decryption code specifies the variable key that was used in the encoding. The format information received with the decryption code specifies the variable key format and a starting value so that the sequence of (preferably pseudo-random) values making up the variable key can be reproduced.

In one embodiment, the variable key can be generated according to a seed value provided to a linear feedback shift register (LFSR) circuit within data processor 120. The LFSR circuit may alternatively form part of receiver 110 separate from, but accessible to, data processor 120. The sequence of pseudo-random values generated by the LFSR circuit in step 350 will be the same as those used in the encoding process, provided the same seed value is input into the LFSR circuit and the LFSR circuits on the encoding and decoding sides use the same tapping points. Instead of using an LFSR circuit to generate a pseudo-random number sequence, alternative methods of repeatably generating a number sequence may be used, resulting in either a pseudo-random number sequence or a non-random number sequence.

The sequence of numbers constituting the variable key may be a repeating sequence and may be pseudo-random. Importantly, the variable key must be repeatable, so that the same sequence used in the encoding can be generated during the decoding process. For this purpose, a starting value or seed value of the variable key is recorded together with the encoding key in the data record for data service 145 stored in database 160. The variable key may be generated using a LFSR circuit, such as is described and shown in U.S. patent application Ser. No. 11/350,839, using a particular seed value and having predetermined tapping points. In such a case, the configuration of the tapping points is also stored in the data record and transmitted with the seed value in the format information.

By reading the data service 145 into a buffer and processing it using a key specific to the receiver 110 (such as its unique identifier), and receiving a decryption key from code provider 150 that is derived from the original encoding key used for the particular data service 145 (i.e. channel) and a key specific to the receiver 110, the original encryption key used for the data service 145 is never provided as such. Rather, the encryption key is used with the device-specific key to generate, at code provider 150, a receiver-specific decryption key, which is then sent to the data processor 120 of receiver 110.

The application of the keys, and the transformation of the data using the keys, is illustrated in Table 1 below, using example data and key values for a data block size of one byte. Each row in Tables 1, 2A and 2B indicates an example buffered data block at an arbitrary time t, t+1, . . . , t+n, as the received data stream is encrypted and decrypted over time.

TABLE 1

| | | | Data Sent on Data | | | | Decoded | |
|---|---|---|---|---|---|---|---|---|
| | | | Link | | Data Received | | with Key C | |
| | | | Key A | Production | Key B | Player | Key C | Decoding |
| Time | Original Data | | 5C | 01011100 | E5 | 11100101 | B9 | 10111001 |
| Data | Original | Original | Disc | Disc | Player | Player | Final | Final |
| Time | Data | Binary | Data | Binary | Data | Binary | Data | Binary |
| t | 2D | 00101101 | 71 | 01110001 | 94 | 10010100 | 2D | 00101101 |
| t + 1 | 3C | 00111100 | 60 | 01100000 | 85 | 10000101 | 3C | 00111100 |
| t + 2 | 4E | 01001110 | 12 | 00010010 | F7 | 11110111 | 4E | 01001110 |
| t + 3 | 2A | 00101010 | 76 | 01110110 | 93 | 10010011 | 2A | 00101010 |
| t + 4 | F4 | 11110100 | A8 | 10101000 | 4D | 01001101 | F4 | 11110100 |
| t + 5 | D6 | 11010110 | 8A | 10001010 | 6F | 01101111 | D6 | 11010110 |
| t + 6 | 54 | 01010100 | 08 | 00001000 | ED | 11101101 | 54 | 01010100 |
| t + 7 | 67 | 01100111 | 3B | 00111011 | DE | 11011110 | 67 | 01100111 |
| t + 8 | 8A | 10001010 | D6 | 11010110 | 33 | 00110011 | 8A | 10001010 |
| t + 9 | FE | 11111110 | A2 | 10100010 | 47 | 01000111 | FE | 11111110 |
| t + 10 | 7E | 01111110 | 22 | 00100010 | C7 | 11000111 | 7E | 01111110 |
| t + 11 | 8D | 10001101 | D1 | 11010001 | 34 | 00110100 | 8D | 10001101 |
| t + 12 | 56 | 01010110 | 0A | 00001010 | EF | 11101111 | 56 | 01010110 |
| t + 13 | 5B | 01011011 | 07 | 00000111 | E2 | 11100010 | 5B | 01011011 |
| t + 14 | B1 | 10110001 | ED | 11101101 | 08 | 00001000 | B1 | 10110001 |
| t + 15 | 1D | 00011101 | 41 | 01000001 | A4 | 10100100 | 1D | 00011101 |
| t + 16 | D4 | 11010100 | 88 | 10001000 | 6D | 01101101 | D4 | 11010100 |
| t + 17 | 04 | 00000100 | 58 | 01011000 | BD | 10111101 | 04 | 00000100 |
| t + 18 | F0 | 11110000 | AC | 10101100 | 49 | 01001001 | F0 | 11110000 |
| t + 19 | 30 | 00110000 | 6C | 01101100 | 89 | 10001001 | 30 | 00110000 |
| t + 20 | 0F | 00001111 | 53 | 01010011 | B6 | 10110110 | 0F | 00001111 |
| t + 21 | 1F | 00011111 | 43 | 01000011 | A6 | 10100110 | 1F | 00011111 |
| t + 22 | DE | 11011110 | 82 | 10000010 | 67 | 01100111 | DE | 11011110 |
| t + 23 | BA | 10111010 | E6 | 11100110 | 03 | 00000011 | BA | 10111010 |
| t + 24 | A0 | 10100000 | FC | 11111100 | 19 | 00011001 | A0 | 10100000 |
| t + 25 | 55 | 01010101 | 09 | 00001001 | EC | 11101100 | 55 | 01010101 |
| t + 26 | 44 | 01000100 | 18 | 00011000 | FD | 11111101 | 44 | 01000100 |
| t + 27 | 12 | 00010010 | 4E | 01001110 | AB | 10101011 | 12 | 00010010 |
| t + 28 | 00 | 00000000 | 5C | 01011100 | B9 | 10111001 | 00 | 00000000 |
| t + 29 | FF | 11111111 | A3 | 10100011 | 46 | 01000110 | FF | 11111111 |
| t + 30 | 45 | 01000101 | 19 | 00011001 | FC | 11111100 | 45 | 01000101 |
| t + 31 | 54 | 01010100 | 08 | 00001000 | ED | 11101101 | 54 | 01010100 |

| | | | |
|---|---|---|---|
| Column 1 | Column 2 | Column 3 | Column 4 |

Column 1 of Table 1 shows the original data prior to encryption, in hexadecimal and binary form. Column 2 shows the data of column 1 after it has been passed through an XOR function with key A is ready for transmission to receiver 110. Key A is the original encoding key, which is stored in the data record of the data service 145 maintained in database 160 accessible to code provider 150. Key A may be a random key value allocated to the data service 145 and stored in the data record in database 160.

Column 3 of Table 1 shows the data of column 2 when read into a buffer of receiver 110 and processed with key B using an XOR function. Key B is the unique identifier of the receiver 110 supplied to code provider 150 with the (channel) service request. Column 4 shows the data of column 3 processed with key C using an XOR logic function, thereby generating the original data of column 1. Key C is the decryption key generated by code provider 150 from keys A and B using, in this example, an XOR logic function. Thus, in this example, key C equals key A XOR key B. Depending on the logic functions used in the encryption, the logic function used to generate key C from keys A and B may vary. This relationship may be generalized as C=f(A, B), where f( ) is a logic function (which may itself be comprised of a combination of logic functions). Key C may then be used to obtain the original data using the logical inverse of f( ). In other words, if the data encoded using keys A and B is a function of the original data, the original data is obtained by applying an inverse of that function to the encoded data using key C.

Referring now to FIG. 4, a method of updating an encryption key is described in further detail and is designated generally by reference numeral 400. Method 400 begins at step 410, at which the code provider 150 sets a validity period of each encryption key for each data service.

At step 420, code provider checks whether the validity period of any encryption key has expired. This step is performed repeatedly until code provider 150 determines that an encryption key has expired, after which step 430 is performed.

At step 430, code provider 150 generates a new encryption code for each service having an expired encryption key. The new encryption code comprises a new encryption key and may comprise new format information specifying the logic functions and other parameters to be used in the encryption of the data service. The new encryption key may be generated according to a random number generation process known to those skilled in the art.

At step 440, code provider 150 generates a new decryption code for each subscriber of the service, based on the newly selected encryption code and the receiver identifier of each subscriber. The format information of the new decryption code is determined from the new format information of the new encryption code so that the encryption process can be suitably reversed during the decryption process. Code provider 150 then proceeds to transmit the new decryption codes to the receiver 110 of each subscriber, at step 450.

Method 400 allows code provider 150 to regularly update the encryption keys for each channel while providing decryption keys to the subscribers that are specific to each subscriber's receiver. If encrypted data service 145 is a time limited service, such as a video-on-demand service or a monthly trial subscription then steps 440 to 450 are not performed once the validity period of the encryption key expires. This is because the encrypted data service 145 becomes encrypted with a new encryption key following step 430 and the subscriber will need to resubscribe to the service in order to receive the new decryption code.

Turning now to Tables 2A and 2B, encryption and decryption of the data service 145 using a variable key is described in further detail. As with column 1 of Table 1, column 1 in Table 2A shows the original data, prior to being encoded. Each of the columns of Tables 1, 2A and 2B show the data in hexadecimal form, as well as in binary form, using an example data block size of one byte for illustrative purposes. The keys used in the encryption and decryption are also one byte in the illustrated examples. The encryption and decryption keys are preferably, although not necessarily, the same size as the data blocks. It should be understood that the size of the data blocks and keys may vary depending on the requirements.

TABLE 2A
Process at the encoding of the data stream

| | | | | | Intermediate Data | | | |
|---|---|---|---|---|---|---|---|---|
| | | | Variable Key | | Data | | Data Stream Sent | |
| | | | LFSR | | XORed with | | Key A | Production |
| Time | Original Data | | Seed | 0 × 08 | Variable LFSR Key | | 5C | 01011100 |
| Data | Original | Original | LFSR | LFSR | Intermediate Data | | Data | Data |
| Time | HEX | Binary | KEY | Binary | HEX | Binary | HEX | Binary |
| t | 2D | 00101101 | 08 | 00001000 | 25 | 00100101 | 79 | 01111001 |
| t + 1 | 3C | 00111100 | 03 | 00000011 | 3F | 00111111 | 63 | 01100011 |
| t + 2 | 4E | 01001110 | 06 | 00000110 | 48 | 01001000 | 14 | 00010100 |
| t + 3 | 2A | 00101010 | 0C | 00001100 | 26 | 00100110 | 7A | 01111010 |
| t + 4 | F4 | 11110100 | 0B | 00001011 | FF | 11111111 | A3 | 10100011 |
| t + 5 | D6 | 11010110 | 05 | 00000101 | D3 | 11010011 | 8F | 10001111 |
| t + 6 | 54 | 01010100 | 0A | 00001010 | 5E | 01011110 | 02 | 00000010 |
| t + 7 | 67 | 01100111 | 07 | 00000111 | 60 | 01100000 | 3C | 00111100 |
| t + 8 | 8A | 10001010 | 0E | 00001110 | 84 | 10000100 | D8 | 11011000 |
| t + 9 | FE | 11111110 | 0F | 00001111 | F1 | 11110001 | AD | 10101101 |
| t + 10 | 7E | 01111110 | 0D | 00001101 | 73 | 01110011 | 2F | 00101111 |
| t + 11 | 8D | 10001101 | 09 | 00001001 | 84 | 10000100 | D8 | 11011000 |
| t + 12 | 56 | 01010110 | 01 | 00000001 | 57 | 01010111 | 0B | 00001011 |
| t + 13 | 5B | 01011011 | 02 | 00000010 | 59 | 01011001 | 05 | 00000101 |
| t + 14 | B1 | 10110001 | 04 | 00000100 | B5 | 10110101 | E9 | 11101001 |
| t + 15 | 1D | 00011101 | 08 | 00001000 | 15 | 00010101 | 49 | 01001001 |
| t + 16 | D4 | 11010100 | 03 | 00000011 | D7 | 11010111 | 8B | 10001011 |
| t + 17 | 04 | 00000100 | 06 | 00000110 | 02 | 00000010 | 5E | 01011110 |
| t + 18 | F0 | 11110000 | 0C | 00001100 | FC | 11111100 | A0 | 10100000 |
| t + 19 | 30 | 00110000 | 0B | 00001011 | 3B | 00111011 | 67 | 01100111 |
| t + 20 | 0F | 00001111 | 05 | 00000101 | 0A | 00001010 | 56 | 01010110 |
| t + 21 | 1F | 00011111 | 0A | 00001010 | 15 | 00010101 | 49 | 01001001 |
| t + 22 | DE | 11011110 | 07 | 00000111 | D9 | 11011001 | 85 | 10000101 |
| t + 23 | BA | 10111010 | 0E | 00001110 | B4 | 10110100 | E8 | 11101000 |
| t + 24 | A0 | 10100000 | 0F | 00001111 | AF | 10101111 | F3 | 11110011 |
| t + 25 | 55 | 01010101 | 0D | 00001101 | 58 | 01011000 | 04 | 00000100 |
| t + 26 | 44 | 01000100 | 09 | 00001001 | 4D | 01001101 | 11 | 00010001 |
| t + 27 | 12 | 00010010 | 01 | 00000001 | 13 | 00010011 | 4F | 01001111 |
| t + 28 | 00 | 00000000 | 02 | 00000010 | 02 | 00000010 | 5E | 01011110 |
| t + 29 | FF | 11111111 | 04 | 00000100 | FB | 11111011 | A7 | 10100111 |
| t + 30 | 45 | 01000101 | 08 | 00001000 | 4D | 01001101 | 11 | 00010001 |
| t + 31 | 54 | 01010100 | 03 | 00000011 | 57 | 01010111 | 0B | 00001011 |

| | | | |
|---|---|---|---|
| This is the original | This is the data | This is the data | The data is encoded |
| data to be encrypted | generated by a | generated by | using Key A and sent |
| | LFSR circuit | XOR of the first | via the data link |
| | (15 values) | two columns | |
| COLUMN 1 | COLUMN 2 | COLUMN 3 | COLUMN 4 |

TABLE 2B
Process at the decoding of the data stream

| | | | | | Decoded | |
|---|---|---|---|---|---|---|
| | Data | | Decoded | | with LFSR Key | |
| | Stream Received | | with Key C | | Data XORed | |
| | Key B | Receiver | Key C | Decoding | with Variable | |
| | E5 | 11100101 | B9 | 10111001 | LFSR Key | |
| Time | Re- | Re- | De- | De- | | Final |
| Data | ceiver | ceiver | coded | coded | Final | Bi- |
| Time | Data | Binary | Data | Binary | Data | nary |
| t | 9C | 10011100 | 25 | 00100101 | 2D | 00101101 |
| t + 1 | 86 | 10000110 | 3F | 00111111 | 3C | 00111100 |
| t + 2 | F1 | 11110001 | 48 | 01001000 | 4E | 01001110 |
| t + 3 | 9F | 10011111 | 26 | 00100110 | 2A | 00101010 |
| t + 4 | 46 | 01000110 | FF | 11111111 | F4 | 11110100 |
| t + 5 | 6A | 01101010 | D3 | 11010011 | D6 | 11010110 |
| t + 6 | E7 | 11100111 | 5E | 01011110 | 54 | 01010100 |
| t + 7 | D9 | 11011001 | 60 | 01100000 | 67 | 01100111 |
| t + 8 | 3D | 00111101 | 84 | 10000100 | 8A | 10001010 |
| t + 9 | 48 | 01001000 | F1 | 11110001 | FE | 11111110 |
| t + 10 | CA | 11001010 | 73 | 01110011 | 7E | 01111110 |
| t + 11 | 3D | 00111101 | 84 | 10000100 | 8D | 10001101 |
| t + 12 | EE | 11101110 | 57 | 01010111 | 56 | 01010110 |
| t + 13 | E0 | 11100000 | 59 | 01011001 | 5B | 01011011 |
| t + 14 | 0C | 00001100 | B5 | 10110101 | B1 | 10110001 |
| t + 15 | AC | 10101100 | 15 | 00010101 | 1D | 00011101 |
| t + 16 | 6E | 01101110 | D7 | 11010111 | D4 | 11010100 |
| t + 17 | BB | 10111011 | 02 | 00000010 | 04 | 00000100 |
| t + 18 | 45 | 01000101 | FC | 11111100 | F0 | 11110000 |
| t + 19 | 82 | 10000010 | 3B | 00111011 | 30 | 00110000 |
| t + 20 | B3 | 10110011 | 0A | 00001010 | 0F | 00001111 |
| t + 21 | AC | 10101100 | 15 | 00010101 | 1F | 00011111 |
| t + 22 | 60 | 01100000 | D9 | 11011001 | DE | 11011110 |
| t + 23 | 0D | 00001101 | B4 | 10110100 | BA | 10111010 |
| t + 24 | 16 | 00010110 | AF | 10101111 | A0 | 10100000 |
| t + 25 | E1 | 11100001 | 58 | 01011000 | 55 | 01010101 |
| t + 26 | F4 | 11110100 | 4D | 01001101 | 44 | 01000100 |
| t + 27 | AA | 10101010 | 13 | 00010011 | 12 | 00010010 |
| t + 28 | BB | 10111011 | 02 | 00000010 | 00 | 00000000 |
| t + 29 | 42 | 01000010 | FB | 11111011 | FF | 11111111 |
| t + 30 | F4 | 11110100 | 4D | 01001101 | 45 | 01000101 |
| t + 31 | EE | 11101110 | 57 | 01010111 | 54 | 01010100 |

| | | |
|---|---|---|
| The receiver | Key C is a product | The data is |
| receives the data | of Key A XOR | XORed with the |
| stream and XORs it | Key B | variable key to |
| with Key B | | get the original |
| | | data |

Column 2 of Table 2A shows a variable key generated by an LFSR circuit, based on an example seed value of 8 and a particular tapping configuration. Column 3 shows the original data encoded with the variable key value using an XOR function. The data of column 3 is then further encoded with a fixed key (key A) using an XOR function and is sent to the receiver 110 in the form shown in column 4.

Column 5 shows the data of column 4 as read by receiver 110, using key B, which is the unique identifier of the receiver 110. Once the decoding key C is received from code provider 150, the data of column 5 is processed using key C and an XOR function, to generate the intermediately decoded data shown in column 6. The data of column 6 is then processed using the variable key values of column 2 and an XOR function to generate the fully decoded data shown in column 7, which is the same as the original data shown in column 1. While the logic functions used in this example are all XOR functions, it should be understood that other suitable functions may be used in the encoding and decoding processes, providing the encoding logic functions have suitable inverse functions for the decoding process.

While Tables 2A and 2B show an example of data encoding and decoding using a fixed key in combination with a variable key, alternative embodiments may use only a variable key or may use two or more fixed or variable keys instead of a combination.

Where variable key encryption is employed in encrypting the data service 145, because the data service 145 is a continuous stream of data, it is necessary to synchronize the generation of the variable key at the receiver 110 so as to match the variable encryption key used for a given data block of the incoming data stream. For this purpose, the format information may include synchronization information and the encrypted data service 145 may include synchronization markers to enable the receiver 110 to appropriately synchronize generation of the variable decryption key. Such synchronization markers may be provided as a sequence of reserved data values that are parsed by data processor 120 as ‘invalid’ and are removed from the data stream.

Alternatively, synchronization may be achieved by repeating the variable key sequence after a predetermined number of bytes or data blocks and using a moving window of the same size as the predetermined number of bytes or data blocks while attempting to decrypt the data in the window into meaningful information. Whether the decrypted data is meaningful may be determined, for example, by parsing the decrypted data for delimiters, such as frame markers or headers. Achieving synchronization by decrypting a moving window of the incoming data stream may slow down the data processing slightly, but will not have a noticeable effect from the consumer's perspective. However, this synchronization method encrypts any data delimiters in the data stream so that the incoming data stream will not have any discernable formatting to the receiver unless the receiver can determine which decryption format to use.

In a further embodiment, the two described synchronization methods may be combined, so that synchronization markers are embedded within the data stream and encrypted as part of it, so that when the moving window is at the right synchronization point, the synchronization markers are revealed after the first level of decryption. However the synchronization is done, the information to determine the appropriate synchronization markers and/or window size is included in the format information received with the decryption code.

Referring now to Tables 3A, 3B and 3C, examples of format information comprised in the decryption code are illustrated. In Table 3A, an example of format information is shown, for the case where the format information includes a key lifetime value, for example as a number of hours. The lifetime value indicates the time during which the decryption key transmitted with the format information is valid. Once the key lifetime expires, the decryption key becomes unusable by receiver 110, either because receiver 110 is programmed to discard the expired key or because the expired key is updated by code provider 150 and is not provided to receiver 110.

TABLE 3A
Example of decryption format using variable key and time out value

| Validation | | Seed | Key | |
|---|---|---|---|---|
| Checksum | Format Code | Value | Life (hours) | |
| 005BDE | 00 | 5BA2 | 003C | |
| 23518 | 0 | 23458 | 60 | |
| Code Value: | | | 2 | Days |

| | | |
|---|---|---|
| 23518, 0, 23458, 60 | 12 | Hours |

The first 3 bytes is the checksum of the whole packet
The next 2 bytes is the format code for the particular data service
The next 2 bytes is the seed value for the variable key
The last 2 bytes is the number of hours the channel is allowed to decode
The key life can be computed from the number of days and hours

TABLE 3B
Examples of decryption format
using variable key and start & end date

| | | | First | | Last | |
|---|---|---|---|---|---|---|
| Validation | Format | Seed | Valid | | Valid | |
| Checksum | Code | Value | Date | | Date | |
| 005E7B | 01 | 5BA2 | 016C | | 016D | |
| 24187 | 1 | 23458 | 364 | | 365 | |
| | | | 31 | Date | 1 | Date |
| Key Value: | | | 12 | Month | 1 | Month |

| | | | | |
|---|---|---|---|---|
| 24265, 1, 23458, 403, 404 | 2005 | Year | 2006 | Year |

The first 3 bytes is the checksum of the whole packet
The next 2 bytes is the format code for the particular data service
The next 2 bytes is the seed value for the variable key
The next 2 bytes is the starting day (in days from January 1^{st}, 2005)
The last 2 bytes is the date when the decoder stops decoding the channel

TABLE 3C
Example of decryption format using
variable key, time out value and Channel ID

| | | Channel | | Program | |
|---|---|---|---|---|---|
| Validation | Format | ID | Seed | ID | Key Life |
| Checksum | Code | Number | Value | Number | (Hours) |
| 0029CC | 02 | 89 | 290D | 0031 | 0003 |
| 10700 | 2 | 137 | 10509 | 49 | 3 |
| Code Value: | | | | | |

10700, 2, 137, 10509, 49, 3
The first 3 bytes is the checksum of the whole packet
The next 2 bytes is the format code for a particular channel
The next 2 bytes is the channel ID (key is only valid for this channel)
The next 2 bytes is the seed value for the variable key
The next 2 bytes is the Program ID number (can be used to identify the program)
The last 2 bytes is the number of hours the channel is allowed to decode
The key life can be computed from the number of days and hours

In the examples illustrated in Tables 3A to 3C, the format information includes a validation checksum for checking whether the decryption key and format information may have been corrupted, for example during transmission from the code provider 150. Other suitable forms of validation may be used instead of a checksum. Further, the format information includes a key format code, which the receiver 110 uses to determine (according to a stored reference table in memory 122) which logic functions and decoding methods to use in the decoding process. For example, the key format code may specify a format that uses a combination of XOR functions and hash functions and specifies that an LFSR circuit is to be used to generate a pseudo-random number sequence based on a seed value transmitted with the format information. In another example, the key format code may specify a format that does not employ variable key decoding or that does not specify a key lifetime. Accordingly, the key format code will dictate whether the variable key seed value or key lifetime value is necessary for the decoding process.

In Table 3B, an example of format information is shown where the format information includes a specified validity period of the decryption key, including a start and end date during which the decryption key is valid. The format information in these examples also includes a validation checksum, a format code and a seed value.

In Table 3C, there is shown format information for a decryption code for a specific channel and having a key lifetime value. The key lifetime value in this example operates in a similar manner to that described in relation to Table 3A. In this example, however, a unique identifier of the channel is included with the format information, as well as a program identification code for identifying a particular program to be displayed on the channel.

While the decryption key is not shown in the examples of format information shown in Tables 3A to 3C, the decryption key follows the format information within the decryption code as a distinct data field within the code. Thus, in parsing the decryption code, data processor 120 first parses the format information and then parses the decryption key. This allows the decryption key to be embedded within a larger number of superfluous bits that can be stripped away as specified by a field in the format information. For example, the format information may instruct the parser to select only a particular 8 of the 16 bits in the key field as the decryption key.

In one embodiment, the data block size may be varied in the encoding process. For example, a pseudo-random or non-random number sequence may be used to determine the block size of each data block. If the number sequence is pseudo-random, an LFSR circuit may be used to generate the number sequence. During decoding, the same pseudo-random or non-random number sequence is used to determine the data block size. If the encoding process used varying data block sizes, this is indicated by the format code transmitted with the decryption code and the format information includes a seed value for generating the appropriate number sequence.

Embodiments of the invention are described above illustrated in the Figures. It should be understood that these embodiments are provided by way of example only and that some variation or modification of the features and/or elements of the embodiments may be made without departing from the spirit and scope of the invention, and all such variations and modifications are included within that scope.

1. A data processing method comprising:
generating at a subscriber terminal a service request, the service request including a service identifier and a unique identifier of the subscriber terminal;
providing the service request to a validation entity;
receiving a decryption code from the validation entity in response to the service request, the decryption code being based on the unique identifier and an encryption key;
receiving an encrypted data service at the subscriber terminal, the encrypted data service being associated with the service identifier and being encrypted using the encryption key; and
processing the encrypted data service using the decryption code to generate decrypted data.

2. The method of claim 1, wherein the encrypted data service is a subscription-based service received from a service provider remote from the subscriber terminal.

3. The method of claim 2, wherein the subscription-based service is a cable television service.

4. The method of claim 2, wherein the subscription-based service is a satellite television service.

5. The method of claim 3, wherein the service identifier includes a channel identifier corresponding to a television channel of the subscription-based service.

6. The method of claim 4, wherein the service identifier includes a channel identifier corresponding to a television channel of the subscription-based service.

7. The method of claim 1, wherein the processing includes performing a first logic operation on the encrypted data service using a first logic function and the unique identifier to generate partially decrypted data.

8. The method of claim 7, wherein the processing further includes performing a second logic operation on the partially decrypted data using a second logic function and the decryption code.

9. The method of claim 1, wherein the decryption code includes a decryption key and format information.

10. The method of claim 9, wherein the format information includes the service identifier.

11. The method of claim 9, wherein the format information includes a validation code for validating the decryption code.

12. The method of claim 9, wherein the format information includes a format code, the format code specifying one or more logic functions to be used in the processing.

13. The method of claim 12, wherein the format code specifies whether a variable decryption key is to be used in the processing and, if the variable decryption key is to be used, the format information includes a seed value for generating the variable decryption key.

14. The method of claim 8, wherein performing the second logic operation generates further partially decrypted data and the processing further includes performing a third logic operation on the further partially decrypted data using a third logic function and a variable decryption key generated based on the decryption code.

15. The method of claim 14, wherein the variable decryption key comprises a number sequence generated based on a seed value specified in the decryption code.

16. The method of claim 15, wherein the number sequence is a pseudo-random number sequence.

17. The method of claim 16, wherein the pseudo-random number sequence is generated by a linear feedback shift register circuit.

18. A method of providing a service, comprising:
receiving at a validation entity a service request for an encrypted data service, the service request including a service identifier and a unique identifier of a subscriber terminal;
generating a decryption code in response to the service request based on an encryption code and the unique identifier;
providing the decryption code to the subscriber terminal;
encrypting a data service corresponding to the service identifier using the encryption code; and
transmitting the encrypted data service to the subscriber terminal for decryption of the encrypted data service by the subscriber terminal using the decryption code.

19. The method of claim 18, wherein the encrypted data service is a subscription-based service.

20. The method of claim 19, wherein the subscription-based service is a cable television service.

21. The method of claim 19, wherein the subscription-based service is a satellite television service.

22. The method of claim 18, wherein the service request is received from the subscriber terminal.

23. The method of claim 18, wherein the providing includes transmitting the decryption code to the subscriber terminal over a transmission medium specific to the data service.

24. The method of claim 18, wherein the providing includes transmitting the decryption code to the subscriber terminal over a network.

25. The method of claim 18, further comprising, prior to the step of generating, the step of validating the service request.

26. The method of claim 25, wherein the step of validating includes checking the service request against a subscriber account status.

27. The method of claim 18, wherein the encrypted data service includes one or more channels.

28. The method of claim 27, wherein the service identifier comprises one or more channel identifiers.

29. The method of claim 18, wherein the decryption code includes a decryption key and format information.

30. The method of claim 29, wherein the format information includes the service identifier.

31. The method of claim 29, wherein the format information includes a validation code for validating the decryption code.

32. The method of claim 29, wherein the format information includes a format code, the format code specifying one or more logic functions to be used in the decryption.

33. The method of claim 32, wherein the format code specifies whether a variable decryption key is to be used in the decryption and, if the variable decryption key is to be used, the format information includes a seed value for generating the variable decryption key.

34. The method of claim 18, wherein the encrypted data service includes a radio service.

35. A data processing device for an encrypted data service, the device comprising:
a processor for receiving and processing an encrypted data service from a service provider, the processor being configured to determine a first unique identifier of the encrypted data service; and
a memory storing a decryption code corresponding to the first unique identifier and a second unique identifier of the data processing device;
wherein the processor is configured to decrypt the encrypted data service based on the decryption code and the second unique identifier.

36. The device of claim 35, further comprising means for communicating with a code provider associated with the service provider to receive the decryption code for the encrypted data service.

37. The device of claim 35, wherein the decryption code includes a decryption key and format information and wherein the processor is configured to determine a decryption format of the encrypted data service based on the format information and to decrypt the encrypted data service based on the decryption key, the decryption format and the second unique identifier.

38. The device of claim 35, wherein the encrypted data service forms part of a television service.

39. The device of claim 38, wherein the encrypted data service comprises a cable television channel.

40. The device of claim 38, wherein the encrypted data service comprises a satellite television channel.

41. The device of claim 38, wherein the encrypted data service comprises a video-on-demand service.

42. The device of claim 38, wherein the encrypted data service comprises a pay-per-view service.

43. The device of claim 37, wherein the format information includes the first unique identifier.

44. The device of claim 37, wherein the format information includes a validation code for validating the decryption code.

45. The device of claim 37, wherein the format information includes a format code, the format code specifying one or more logic functions to be used in the decryption.

46. The device of claim 37, wherein the format code specifies whether a variable decryption key is to be used in the decryption and, if the variable decryption key is to be used, the format information includes a seed value for generating the variable decryption key.

47. The device of claim 35, wherein the first unique identifier includes a channel identifier corresponding to a television channel of the encrypted data service.

48. The device of claim 35, wherein the processor is configured to perform a first logic operation on the encrypted data service using a first logic function and the second unique identifier to generate partially decrypted data.

49. The device of claim 48, wherein the processor is further configured to perform a second logic operation on the partially decrypted data using a second logic function and the decryption code.

50. The device of claim 49, wherein the output of the second logic operation is further partially decrypted data and the processor is further configured to perform a third logic operation on the further partially decrypted data using a third logic function and a variable decryption key.

51. The device of claim 50, wherein the processor is configured to determine the variable decryption key based on the decryption code.

52. The device of claim 51, wherein the variable decryption key comprises a number sequence generated based on a seed value specified in the decryption code.

53. The device of claim 52, wherein the number sequence is a pseudo-random number sequence.

54. The device of claim 53, further comprising a linear feedback shift register (LFSR) circuit, wherein the pseudo-random number sequence is generated by the LFSR circuit.

55. The device of claim 35, wherein the encrypted data service includes a radio service.
